(19) United States
(12) Patent Application Publication
(10) Pub. No.: US 2014/0144747 A1
(43) Pub. Date: May 29, 2014

(54) FRICTION PLATE HAVING MECHANICALLY CONNECTED FRICTION MATERIAL

(71) Applicant: Schaeffler Technologies AG & Co. KG, Herzogenaurach (DE)

(72) Inventors: Jeffrey Hemphill, Copley, OH (US); Patrick Lindemann, Wooster, OH (US); Rashid Farahati, Copley, OH (US); Srinath Sistla, Wooster, OH (US)

(73) Assignee: Schaeffler Technologies AG & Co. KG, Herzogenaurach (DE)

(21) Appl. No.: 14/088,683

(22) Filed: Nov. 25, 2013

Related U.S. Application Data
(60) Provisional application No. 61/730,147, filed on Nov. 27, 2012.

(51) Int. Cl. F16D 13/38; B60T 1/06

(52) U.S. Cl. CPC F16D 13/38; B60T 1/065
USPC 192/107 R; 29/525; 188/218 XL

(57) ABSTRACT

A method of forming a friction plate is provided. The method includes force fitting a friction material onto a base to form a mechanical connection between the friction material and the base. A friction plate is also provided. The friction plate includes a base and a friction material force fit onto the base such that a mechanical connection is formed by a shape of the friction material and a shape of the base.

This claims the benefit to U.S. Provisional Patent Application No. 61/730,147, filed on Nov. 27, 2012, which is hereby incorporated by reference herein.

The present disclosure relates to friction plates. Such friction plates may be included in wet clutch packs for use in transmission shifting clutches and brakes or in wet launch clutches for various types of transmissions.

### BACKGROUND

Friction plates for use in a clutch are generally manufactured by bonding friction material, often paper-based, to both sides of a steel core plate using an adhesive, often a phenolic resin which is baked in a press. Grooves for cooling oil may be formed in the friction plate by pressing, grinding, or by leaving material out in positions where grooves are desired.

Forming friction plates by bonding friction material to a steel core plate with adhesive may be expensive. The adhesive may cost as much as the friction material itself and the process for handling the adhesive is very sensitive. The adhesive is also flammable and hazardous and therefore requires special handling. Conditions must be maintained very accurately for each plate or durability and performance problems can occur, such as shudder and delamination, which occurs at the line of adhesive penetration into the friction material, or debonding failures. Using adhesive may also have a negative impact on the clutch environment.

U.S. Pat. No. 4,055,236 describes a brake disc in the form of a metal frame having part-circular apertures in which part-circular pads are inserted and held in place by a dowel. U.S. Pat. No. 7,731,005 describes concentrically arranged friction materials integrally connected to each other.

### SUMMARY OF THE INVENTION

An object of the present invention is to form a friction plate without adhesive bonding Instead, a mechanical connection is created between the friction material and the base.

A method of forming a friction plate is provided. The method includes force fitting a friction material onto a base to form a mechanical connection between the friction material and the base.

A friction plate is also provided. The friction plate includes a base and a friction material force fit onto the base such that a mechanical connection is formed by a shape of the friction material and a shape of the base.

### BRIEF DESCRIPTION OF THE DRAWINGS

The present invention will be further described in a non-limiting manner on the basis of the drawing of preferred embodiments in which:

FIG. 1 shows a portion of a friction plate according to one embodiment of the present invention;

FIG. 2 shows a portion of a friction plate according to another embodiment of the present invention; and

FIG. 3 shows schematically a friction clutch with a plurality of friction plates.

### DETAILED DESCRIPTION

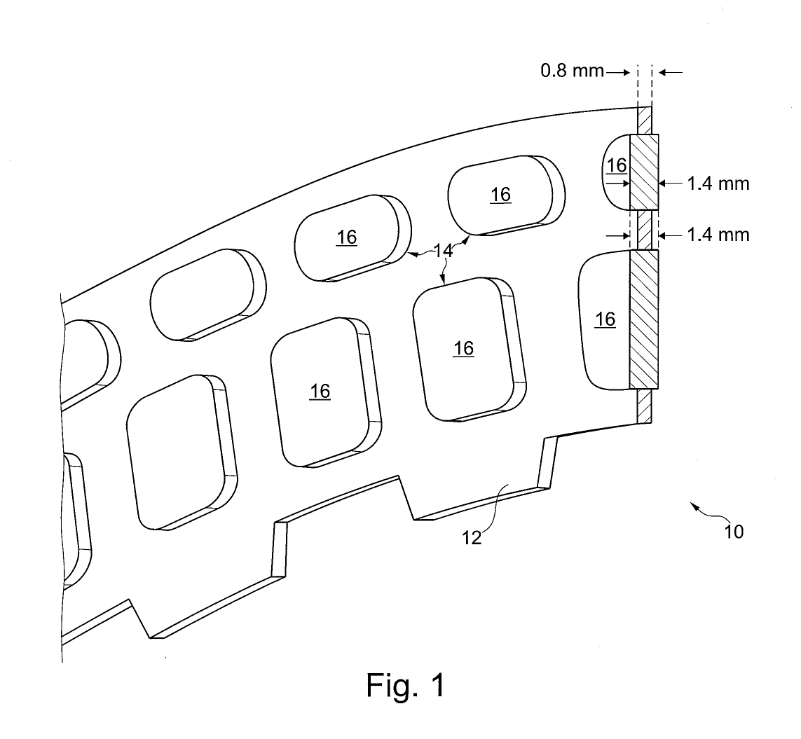

FIG. 1 shows a portion of a friction plate 10 according to one exemplary embodiment of the present invention. Friction plate 10 includes a base 12, here a steel ring, including a plurality of holes 14 formed therein. Friction material is provided in the embodiment shown in FIG. 1 as a plurality of friction material plugs 16. Plugs 16 matching the size and shape of holes 14 are inserted into each of the holes 14. Steel ring 12 may be formed by punching holes 14 therein. Friction material plugs 16 may be formed by a separate punching operation, then inserted into holes 14, or steel ring 12 may be used as a die block, with the friction material being pushed through holes 14 by a punch. Where steel ring 12 is used as a die block, a stamping die may be used to push all of plugs 16 through holes 14 at the same time or a “sewing machine” style operation may employed, where one or multiple plugs 16 may be pressed through holes at a time.

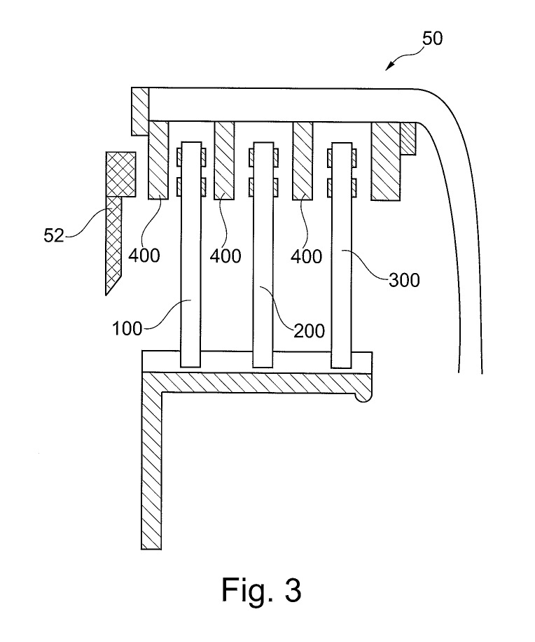

After plugs 16 are inside of holes 14, friction plate 10 may be compressed between flat plates to calibrate the thickness and flatness of plugs 16. The compression of plugs 16 causes the friction material of plugs 16 to expand outwardly towards the edges of holes 14, further locking plugs 16 into holes 14. The compression of plugs 16 causes the friction material to be force fit on steel ring 12 such that plugs 16 and steel ring 12 are mechanically connected by a shape of the friction material and a shape of the base. In a preferred embodiment, friction material 16, after the compression, extends axially past steel ring 12 at least at the protrusions such that the friction material can contact adjacent separator plates 400 (FIG. 3) with without any contact between the separator plates 400 and steel ring 12. In one preferred embodiment, steel ring 12 is approximately 0.8 mm thick and friction material plugs 16 are 1.4 mm thick after being compressed, with friction material plugs 16 protruding axially from both sides of steel ring 12 by 0.3 m. The axially protruding plugs 16 and a surface of steel ring 12, which is recessed with respect to plugs 16, form cooling grooves through which cooling oil may be passed. If the friction material has not been fully cured, friction plate 10 may then be heated to fully cure the friction material plugs 16. In the embodiment shown in FIG. 1, two rows of plugs 16, one row of first size and shape and another row of a second size and shape, are dispersed circumferentially throughout steel ring 12. In other embodiments, more or less than two rows may be dispersed in steel ring 12 and plugs 16 may be of one or more sizes and shapes.

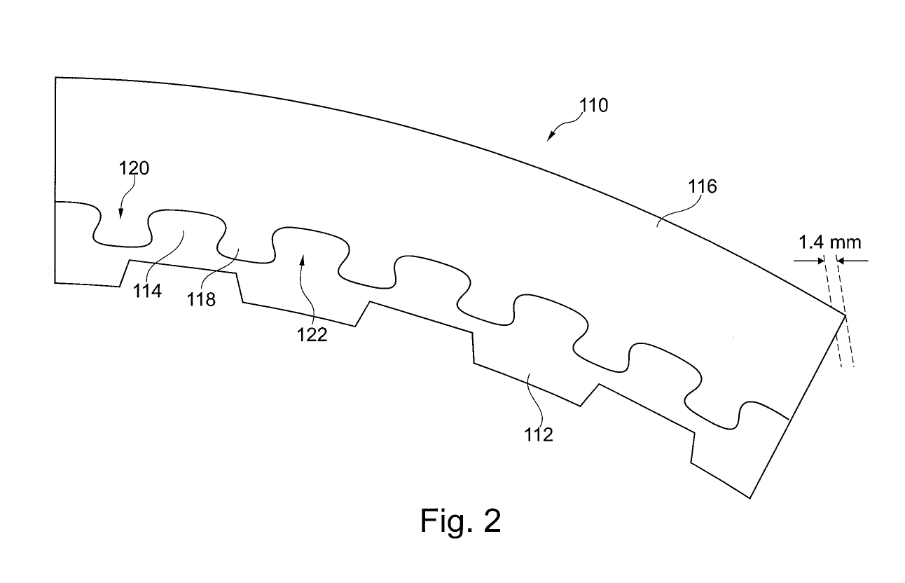

FIG. 2 shows a portion of a friction plate 110 according to another exemplary embodiment of the present invention. Friction plate 110 includes a base 112, here a steel ring, including a plurality of teeth 114 extending radially outward therefrom. Friction material is provided in the embodiment shown in FIG. 2 as a friction material ring 116 positioned on the circumference of steel ring 112. Friction material ring 116 includes a plurality of teeth 118 extending radially inward therefrom. Rings 112, 116 are shaped such that teeth 114 interlock with teeth 118 to hold ring 116 in place on ring 112, with teeth 114 matching the shape of spaces 122 formed between teeth 118 and teeth 118 matching the shape of spaces 120 formed between teeth 114. In an alternative embodiment, steel ring 112 and friction material ring 116 may be in opposite positions, with friction material ring 116 having radially outward extending teeth and being on the inside of steel ring 112, which is on the outside of friction material ring 116 and has radially inward extending teeth interlocking with the teeth of friction material ring 116.

After friction material ring 116 is on steel ring 112 in an interlocking manner, friction material ring 116 may be compressed to form cooling grooves on the surface thereof. The compressing operation recesses portions of friction material ring, such that protrusions, similar to the pattern of plugs 16 shown in FIG. 1, extend above the recessed portions. Also, the friction material, even after compression, should extend axially past steel ring 112 at least at the protrusions. In one preferred embodiment, the friction material is compressed by approximately fifty percent at the recessed portions. The compressing operation may also strengthen the friction material, resulting in reinforcement against torsional and centrifugal loading. The compressing operation may also expand friction material ring 116 toward teeth 114 and spaces 120 of steel ring 112, locking friction material ring 116 into place on steel ring 112 and forming a mechanical connection between steel ring 112 and friction material ring 116. The compression of friction material ring 116 causes the friction material to be force fit on steel ring 112 such that friction material ring 116 and steel ring 112 are mechanically connected by a shape of the friction material and a shape of the base. Steel ring 112 and friction material ring 116 are thus joined together without adhesive bonding. After such a compressing operation is performed, an additional compressing operation may be performed, as similarly discussed above with respect to the embodiment in FIG. 1, with friction plate 110 being compressed between flat plates to calibrate the thickness and flatness of friction material ring 116. This additional compressing operation may cause the friction material ring 116 to expand further toward teeth 114 and spaces 122 of steel ring 112, further locking friction material ring 116 into place on steel ring 112 and strengthening the mechanical connection between friction material ring 116 and steel ring 112. In a preferred embodiment, friction material ring 116, after the one or more compressions, extends axially past steel ring 112 at least at the protrusions such that the friction material can contact adjacent separator plates 400 (FIG. 3) with without any contact between the separator plates 400 and steel ring 112.

FIG. 3 shows schematically a wet-type friction clutch 50 of a motor vehicle transmission having a plurality of friction plates 100, 200, 300. Friction plates 100, 200, 300 may be formed in a similar manner as friction plate 10 as described in FIG. 1 or friction plate 110 as described in FIG. 2. The axially-movable plates 100, 200, 300 can be pressed against axially-movable separator plates 400 by a piston 52, for example a hydraulically-actuated piston, to provide frictional engagement.

What is claimed is:

1. A method of forming a friction plate comprising:
force fitting a friction material onto a base to form a mechanical connection between the friction material and the base.

2. The method as recited in claim 1 wherein the force fitting includes providing the friction material on the base and compressing the friction material to form the mechanical connection between the friction material and the base

3. The method as recited in claim 2 wherein the base includes holes therein, the providing including providing the friction material in the holes, the compressing causing the friction material to expand outwardly in the holes to form the mechanical connection.

4. The method as recited in claim 2 wherein the base includes teeth on a circumference thereof and the frictional material includes teeth on a circumference thereof, the compressing causing the teeth of the frictional material to interlock with the teeth of the base.

5. The method as recited in claim 1 wherein the base is a ring and the friction material is a ring, the force fitting causing the friction material to interlock with the base.

6. The method as recited in claim 1 wherein the base is metal.

7. A friction plate comprising:
a base; and
a friction material force fit onto the base such that a mechanical connection is formed by a shape of the friction material and a shape of the base.

8. The friction plate as recited in claim 7 wherein the base is metal ring.

9. The friction plate as recited in claim 7 wherein the base includes a plurality of holes therein, the friction material being formed by plugs inserted in the holes.

10. The friction plate as recited in claim 7 wherein the base is a ring and the friction material is formed as a ring interlocking with the base.

11. The friction plate as recited in claim 10 wherein the base includes a plurality of teeth on a circumference thereof and the friction material includes a plurality of teeth on a circumference thereof, the teeth of the base interlocking with the teeth of the friction material.

12. The friction plate as recited in claim 7 wherein the friction material is in a compressed state so as to lock the friction material onto the base.

13. The friction plate as recited in claim 7 wherein the friction material applies forces towards the base to lock the friction material onto the base.

14. The friction plate as recited in claim 13 wherein the friction material is paper based on the base is a metal ring.

15. The friction plate as recited in claim 7 wherein the friction material extends axially past the base.

16. A wet-type friction clutch comprising:
at least one friction plate as recited in claim 7.
